(19) United States
(12) Patent Application Publication
(10) Pub. No.: US 2023/0243183 A1
(43) Pub. Date: Aug. 3, 2023

(54) Emergency Lock Box Status Module

(71) Applicant: Russell Scott Holmes, Chester, CA (US)

(72) Inventor: Russell Scott Holmes, Chester, CA (US)

(21) Appl. No.: 18/159,739

(22) Filed: Jan. 26, 2023

Related U.S. Application Data
(60) Provisional application No. 63/305,151, filed on Jan. 31, 2022.

(51) Int. Cl. E05B 17/22; E05B 47/00

(52) U.S. Cl. CPC E05B 17/226; E05B 47/00; E05B 2047/0071

(57) ABSTRACT

The present invention provides a device (lock status module) that comprises a status indicator, a power source connected to the status indicator, and a microcontroller having a wireless communication module configured to control the status indicator in response to a status of the lock switch that is installed in a lock box, and a built-in battery holder mounted on the microcontroller.

### FIELD OF THE INVENTION

The present invention relates generally to a status indicator module for emergency locking systems. More specifically, the present invention is a status module that may be used in a fire department’s access lock box, to indicate when the fire lock switch is activated.

### BACKGROUND OF THE INVENTION

In an emergency, a rapid entry system is critical to the success of first responders. In compliance with International Fire Code, police and fire department lock boxes are mounted securely near building doors, gates, and other entrances. If an alarm sounds, emergency personnel receive immediate access to the facility even with no on-site guard needed. Thus, emergency access lock boxes or a fire lock box enables immediate entry to secured perimeters, gates, buildings, and commercial properties. Often times, when a fire lock box switch and/or key switch is used by a fire department personnel, the personnel may forget to close the key switch or lock box. This is because most of the time, the personal is attending to an emergency and may use a different door or gate while exiting the premise, leaving the door or gate unlocked and open. When unlocked fire lock boxes are observed, the customer or building official, usually calls a door or gate contractor to diagnose why the door or gate is open, creating a service charge for the customer. In order to avoid such confusions and situations, an indicator on the emergency lock system that indicates when the switch lock is open would be beneficial.

An objective of the present invention is to provide users with a device that may indicate when the emergency lock box is activated. In other words, the present invention intends to provide users with a device that may be used to indicate the status of lock box associated with a door or gate, that has been accessed by emergency personnel, utility companies, service technicians, etc. The present invention will indicate that the lock box switch or key switch was left on, so the customer can call the personnel that opened the door or gate to close it preventing a service call and charge from the door or gate contractor. To accomplish this, the device will use a connection from a switch or key switch to monitor the status of the lock box. If the key switch is activated, the status module will indicate the status using an LED, a buzzer or other type of indicator. Thus, the present invention is a simple, efficient, and user-friendly addition to all emergency lock systems, that can prevent unnecessary confusions, service charges, and hassles.

### SUMMARY OF THE INVENTION

An objective of the present invention is to provide users with a device that may indicate when the emergency lock box is activated. In other words, the present invention intends to provide users with a device that may be used to indicate the status of lock box associated with a door or gate, that has been accessed by emergency personnel, utility companies, service technicians, etc. The present invention will indicate that the lock box switch or key switch was left on, so the customer can call the personnel that opened the door or gate to close it preventing a service call and charge from the door or gate contractor. To accomplish this, the device will use a connection from a switch or key switch to monitor the status of the lock box. If the key switch is activated, the status module will indicate the status using an LED, a buzzer or other type of indicator. Thus, the present invention is a simple, efficient, and user-friendly addition to all emergency lock systems, that can prevent unnecessary confusions, service charges, and hassles.

### BRIEF DESCRIPTION OF THE DRAWINGS

FIG. 1 is an illustration of one embodiment of the present invention.

FIG. 2 is an illustration of an alternative embodiment of the present invention with an electrical plug.

FIG. 3 is an illustration of one embodiment of the present invention communicatively connected to a user device via internet.

FIG. 4 is an illustration of one embodiment showing a lock box with a lock cylinder.

### DETAIL DESCRIPTIONS OF THE INVENTION

All illustrations of the drawings are to be describing selected versions of the present invention and are not intended to limit the scope of the present invention. All references of user or users pertain to either individual or individuals who would utilize the present invention.

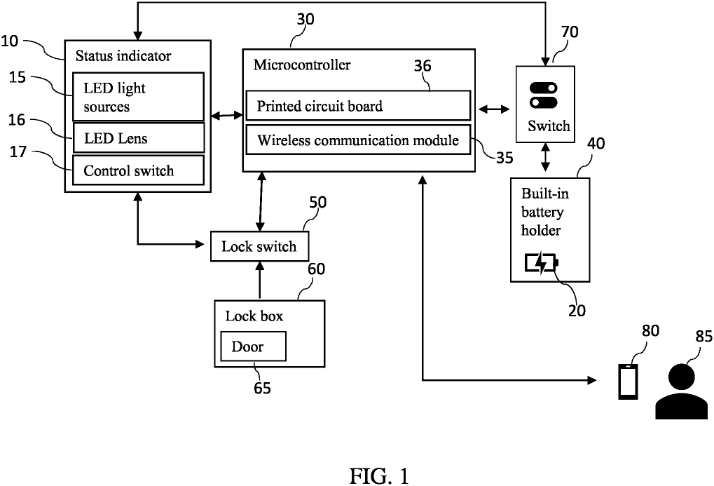

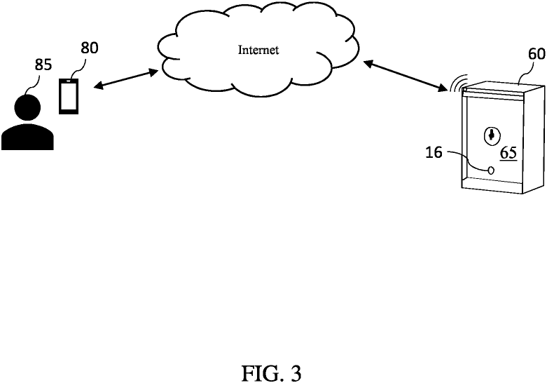

In reference to FIG. 1 through FIG. 4, the present invention is a device which can be called an emergency lock status module. An objective of the present invention is to provide users with a device that may indicate when the emergency lock box is activated. In other words, the present invention intends to provide users with a device that may be used to indicate the status of lock box associated with a door or gate, that has been accessed by emergency personnel, utility companies, service technicians, etc.

The present invention will indicate that the lock box switch or key switch was left on, so the customer can call the personnel that opened the door or gate to close it preventing a service call and charge from the door or gate contractor.

To accomplish this, the device will use a connection from a switch or key switch to monitor the status of the lock box. If the key switch is activated, the status module provided in the present invention will indicate the status using an LED, a buzzer or other type of indicator. Thus, the present invention is a simple, efficient, and user-friendly addition to all emergency lock systems, that can prevent unnecessary confusions, service charges, and hassles.

The following description is in reference to FIG. 1 through FIG. 5. According to a preferred embodiment, the present invention provides a device (lock status module) that comprises a status indicator 10, a power source 20, and a microcontroller 30.

The status indicator 10 may include one or more light-emitting diode (LED) light sources 15.

Preferably, the status indicator 10 is an LED light that can indicate when an associated lock switch 50 or lock box 60 is open.

In some embodiments, the status indicator 10 may be connected to a control switch 17 which can be configured to control signals for the status indicator 10. For example, in some embodiments, the signals from the control switch 17 may be used to modify the frequency of a status indicator’s light flicker, the luminescence of the light, the color of the light, or the timer settings of the light.

In one embodiment, the present invention may include a lock switch 50 which can be known in the art. When the lock switch 50 that can be associated with a gate or a door 65 of a lock box (fire lock box) 60 is opened or activated through the lock box 60, the status indicator 10 that has been installed in the lock box 60 lights up. When the lock switch 50 is closed or deactivated, the LED light or status indicator 10 is turned off.

In the preferred embodiment, the LED (status indicator 10) will shine through an LED lens 16 installed on the lock box 60. Thus, the lock box 60 may include at least one LED lens 16 and the lens size can be determined by the LED size, and the LED may comprise any size, color, type etc.

It should also be noted that, the status indicator 10 may comprise any other technology, technique, mode of attachment etc. that are known to one of ordinary skill in the art, as long as the intents of the present invention are not altered. Examples of other status indicators include, but are not limited to alarm sounds, buzzers, other forms of lights, audible alerts, etc.

In order to provide electrical power to the various components of the present invention, the device (lock status module) of the present invention may comprises the power source 20.

Preferably, the power source 20 comprises two standard, replaceable batteries (AAA) held within a built-in battery holder 40. However, any other power source 20 that is known to one of ordinary skill in the art may be used, as long as the objectives of the present invention are fulfilled. Examples of such power sources include, but are not limited to, Li ion batteries, magnetic power converters, solar power converters, etc.

Further, the power source 20 and the status indicator 10 may be connected to a switch 70, that enables to temporarily shut off and restore the power to the components of the device (status module) of the present invention. Furthermore, in some embodiments, the power source 20 may comprise an electrical terminal or electrical plug 25 that allows the present invention to receive electrical power from an external power source 26.

In the preferred embodiment, the microcontroller 30 is a processing device that manages the operation of the electrical components within the present invention. To that end, the status indicator 10 and the power source 20 are electronically connected to the microcontroller 30, so that the microcontroller 30 is able to dictate the functions of the components of the present invention.

Preferably, the microcontroller 30 includes a processing device (a printed circuit board- PCB) 36 that comprises microelectronic components that can manage the operation of the electrical components within the present invention.

In some embodiments, a built-in battery holder 40 can be mounted on the microcontroller 30. The built-in battery holder can be mounted on top of a PCB to accommodate two standard batteries in series.

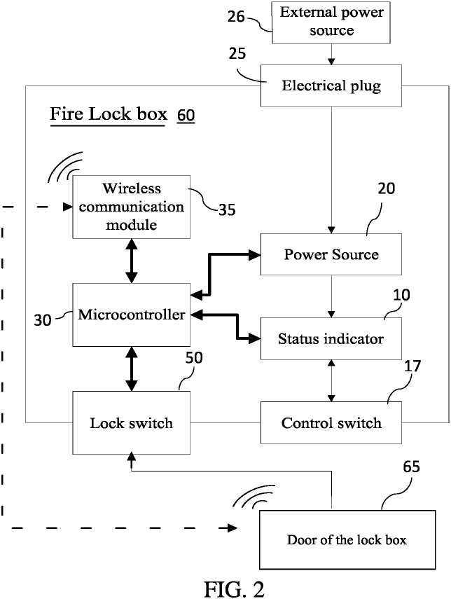

Further, in some embodiments, as shown in FIG. 1 and FIG. 2, the microcontroller 30 may comprise or connected to a wireless communication module 35 (within or connected to the printed circuit board 36), that connects and communicates with external devices via wireless data transmission protocols. Example standards of what the wireless communication module 35 is capable of using various signals including, but are not limited to, Bluetooth, WI-FI, GSM, CDMA, ZigBee, etc. For example, doors (or gates) 65 of the lock box 60 may be wirelessly accessed with the help of the wireless communication module 35.

In such embodiments, the wireless communication module 35 may be communicatively connected to one or more user devices 80 via a network including internet or other signals mentioned above including, but are not limited to, Bluetooth, WI-FI, etc. The user devices 80 may include, but are not limited to, a mobile phone, a smart phone, a personal digital assistant (PDA), a tablet computer, or other similar device having communication capability.

It is an aim of the present invention to indicate the status of a door (or gate) 65 accessed by emergency personnel, utility companies, service technicians, and more.

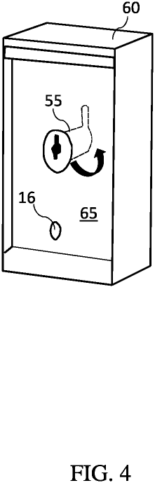

Accordingly, in some embodiments, the present invention may comprise a lock switch 50 mounted on an emergency lock box 60, that is generally installed or connected to gates and/or locked doors 60. Preferably, as shown in FIG. 4, the lock switch 50 can be installed in a lock box 60 that utilizes a lock cylinder 55 specified by the local agencies (such as on a Fire Box) wherein the lock cylinder 55 may be configured to move between a first position to a second position to lock or unlock a gate or door 65 of the lock box 60.

In one embodiment, the lock switch 50 may be operable to mechanically lock a moveable structure 55 to a fixed structure 60. For example, the lock switch may be configured to mechanically lock the lock cylinder (moveable structure) 55 of the lock box (fixed structure) 60.

In some embodiments, the lock switch 50 may be configured to send at least one lock signal or unlock signal to the microcontroller 30 and the microcontroller 30 may be connected to the lock switch 50 to detect a locked status and unlocked status of the lock switch 50. For example, if the lock cylinder 55 is in the first position, the lock switch may mechanically lock the movement of the lock cylinder 55 and send a locked signal to the microcontroller 30 which turns on the LED light (status indicator 10). If a user 85 inserts a key to the lock switch, the lock switch may unlock the movement of the lock cylinder 55 so that the lock cylinder 55 can be moved to the second position. When the lock cylinder 55 is moved to the second position, the lock switch 50 may send an unlocked signal to the microcontroller 30 which turns off the LED light (status indicator 10).

The present invention may be used for other agencies or contractors as well. Lock box examples may include but not be limited to: Fire Lock Box, Knox Lock Box, Postal Lock Box, Police Lock Box, Utility Lock Box, etc. The lock box 60 may be a box made of a suitable material such as metal or plastic material. In some embodiments, the lock box 60 can be of a rectangular shape in any suitable dimension. The lock box 60 can be of any other shape.

Thus, according to the present invention, a connection (wireless or wired) from the lock switch 50 mounted on the lock box 60, enables to access an associated gate or door 65, and the present invention enables to monitor the status of the lock box 60. To that end, the lock switch 50 is electronically connected to the microcontroller 30.

Accordingly, in some embodiments, the microcontroller 30 can be electronically connected to the power source 20 and a lock switch 50 (which can be mounted on a lock box 60), the microcontroller 30 may include a wireless communication module 35 and the microcontroller 30 may include a printed circuit board 36 configured to control the status indicator 10 in response to a status of the lock switch 50.

If the lock switch (or key switch) 50 is activated, the device (status module) of the present invention will indicate the lock status using the status indicator 10 which can be an LED, buzzer or other type of indicator.

Although the invention has been explained in relation to its preferred embodiment, it is to be understood that many other possible modifications and variations can be made without departing from the spirit and scope of the invention.

What is claimed is:

1. A device comprising:
a status indicator;
a power source connected to the status indicator by a switch;
a microcontroller electronically connected to the power source and a lock switch, the microcontroller includes:
a wireless communication module, and
a printed circuit board connected to the wireless communication module and configured to control the status indicator in response to a status of the lock switch, wherein the lock switch is configured to send at least one lock signal or unlock signal to the microcontroller and installed in a lock box that utilizes a lock cylinder specified by one or more local agencies, the lock box includes at least one LED lens; and
a built-in battery holder mounted on the microcontroller.

2. The device as claimed in claim 1, the status indicator comprises one or more light-emitting diode (LED) light sources.

3. The device as claimed in claim 1, the lock switch is configured to mechanically lock a moveable structure to a fixed structure.

4. The device as claimed in claim 1, the wireless communication module is capable of using a Bluetooth, Zigbee and WiFi signal.

5. The device as claimed in claim 1, the lock box is a fire lock box.

6. The device as claimed in claim 1, the wireless communication module is communicatively connected to one or more user devices.

7. The device as claimed in claim 6, the user devices include a mobile phone.

8. A device comprising:
a status indicator having one or more light-emitting diode (LED) light sources;
a power source connected to the status indicator by a switch;
a microcontroller electronically connected to the power source and a lock switch, the microcontroller includes:
a wireless communication module, and
a printed circuit board connected to the wireless communication module and configured to control the status indicator in response to a status of the lock switch, wherein the lock switch is configured to mechanically lock a moveable structure to a fixed structure, the lock switch is installed in a lock box that utilizes a lock cylinder specified by one or more local agencies; and
a built-in battery holder mounted on the microcontroller.

9. The device as claimed in claim 8, the power source includes replaceable batteries.

10. The device as claimed in claim 8, the wireless communication module is capable of using a Bluetooth, Zigbee and WiFi signal.

11. The device as claimed in claim 8, the lock box is a fire lock box.

12. The device as claimed in claim 8, the wireless communication module is communicatively connected to one or more user devices.

13. The device as claimed in claim 12, the user devices include a mobile phone.

14. A device comprising:
a status indicator;
a power source having one or more replaceable batteries connected to the status indicator by a switch;
a microcontroller electronically connected to the power source and a lock switch, the microcontroller includes:
a wireless communication module,
a printed circuit board connected to the wireless communication module and configured to control the status indicator in response to a status of the lock switch, wherein the lock switch is configured to mechanically lock a moveable structure to a fixed structure, the lock switch is installed in a lock box that utilizes a lock cylinder specified by one or more local agencies; and
a built-in battery holder mounted on the microcontroller.

15. The device as claimed in claim 14, the status indicator comprises one or more light-emitting diode (LED) light sources.

16. The device as claimed in claim 14, the wireless communication module is capable of using a Bluetooth, Zigbee and WiFi signal.

17. The device as claimed in claim 14, the lock switch is installed in a lock box that utilizes a lock cylinder specified by one or more local agencies.

18. The device as claimed in claim 14, the lock box is a fire lock box.

19. The device as claimed in claim 14, the wireless communication module is communicatively connected to one or more user devices.

20. The device as claimed in claim 19, the user devices include a mobile phone.
